(19) United States
(12) Patent Application Publication
(10) Pub. No.: US 2004/0014526 A1
(43) Pub. Date: Jan. 22, 2004

(54) Interface arbitrator for allowing multiple devices to share physical input/output interfaces and other resources

(76) Inventor: Charles J. Kulas, San Francisco, CA (US)

Correspondence Address: CHARLES J. KULAS, 651 ORIZABA AVE., SAN FRANCISCO, CA, 94132, US

(21) Appl. No.: 10/198,466

(22) Filed: Jul. 17, 2002

(51) Int. Cl. A63F 9/24; A63F 13/00; G06F 17/00; G06F 19/00

(52) U.S. Cl. 463/43

(57) ABSTRACT

User input and output devices are arbitrated among different processing devices. The devices appear to a user in the traditional model of multiple processes executing on a shared CPU, although each processing device can be a self-contained processing system having dedicated memory, CPU, etc. In a preferred embodiment, a windows-like environment is provided where each device appears as a separate window. Windows can be moved, resized, closed and opened, as is known in the art. A user can interact with information within each window and, hence, immediately and simply access different devices. An interface arbitrator accepts picture element information streams from each device. The arbitrator can be used to designate shared resources, set priorities, launch and shut down devices, and perform other functions. One embodiment provides a game console that can switch between game console functionality and personal computer functionality.

### BACKGROUND OF THE INVENTION

Today's general-purpose computer systems allow a user to load software to perform many types of functions. For example, software, called application programs, can be loaded and executed to play music or videos, perform word processing, browse the Internet, organize files, etc. This general-purpose approach uses an operating system executed by a central processing unit (CPU). The operating system manages the sharing of basic system resources, such as memory, disk storage, access to internal data buses or external communication channels, etc.

Ideally, the operating system arbitrates, or allocates, resources among various application programs so that the resources are shared without conflicts. Since resources are limited and fixed, there is an ongoing, rapid allocation of resources to different processes. For example, portions of processes are continually being swapped between main memory and disk storage. Similarly, portions of high-speed cache memories and pipelines in the CPU need to be updated or flushed every time the CPU switches between processes, or tasks.

Although the general-purpose computing approach has worked well for decades of computer programming it has shortcomings. There is a large overhead involved for software developers to make processes, such as programs or applications, compatible with an operating system. Since the operating system must be in a position of control over the resources, each process must request resources from the operating system. The constant requesting, granting and relinquishing of resources takes time and must be programmed carefully. This “overhead” of requesting resources via an operating system can reduce the speed of many types of applications such as video playback, or computer games. Swapping system resources also results in inefficiencies so that the system performs more slowly, or sometimes not at all.

Each process must also behave properly to be able to function in the overall computing environment with other processes or the system may crash. Stable operation is all the more difficult to achieve because software development companies often work in isolation of each other. Thus, with today's systems, even carefully designed software can cause unforeseen resource conflicts, or other problems, with different manufacturers' software. Developers can not even know what other programs will be co-existing with their own software during operation of the programs because a user is free to install and run any of many available programs.

Some software applications require special hardware. For example, digital video editing software may require a digital video capture card. Audio mixing software may require digital signal processing (DSP) chips interfaced with a computer system. Consumers also want to upgrade and modify the hardware in their systems such as to install a Digital Versatile Disk (DVD) player, network adapter, etc. Each hardware addition is a complex system in itself that typically uses resources of the computer system. Often the addition, or change, of hardware causes obscure and puzzling problems that require hours of troubleshooting. Manufacturers maintain large and expensive technical support systems to help consumers get products to work. Confounding this problem is the recurring theme of manufacturers not being familiar with other hardware and software in a user's system. Often one manufacturer will blame another's hardware or software for causing a problem. Whether this is true or not, the consumer is caught in the middle in a rather helpless predicament.

To make matters worse, operating systems and computer system hardware change often. Sellers of computer systems and operating systems have an obvious incentive to change their products to promote sales. This requires software developers and hardware manufacturers to “hit a moving target” so that their programs work properly with the next projected operating system release. There are different types of computer systems (e.g., Intel or Motorola microprocessor-based) in the consumer marketplace at any point in time. These types are multiplied by the number of different operating systems, and by different versions of the same operating system, so that software developers must design software to work with many different combinations of hardware and operating systems (i.e., “platforms”). Not only does this make the design of stable software overly complex, but the intensive testing required to account for different configurations is becoming prohibitive of predictable and efficient software design.

Often the industry's solution is to obsolete many installed types of computers and software so users are forced to purchase new computer systems and programs to do nearly the same tasks as older software. This has been a huge expense to the consumer, not to mention a waste of hardware and software. Typically, once a CPU is superseded the earlier CPU is never used again in new hardware designs. The design and development of each new CPU is often the largest cost factor in a new computer system.

Another problem with the general-purpose computing approach is that the complexity level of platforms increases. Every next generation computer uses a new, faster and more powerful CPU. This is arguably necessary to handle the newer, more complex operating systems and applications. Users expect the new, more complex, processes to run quickly and want to run many processes at the same time without a noticeable degradation in speed.

Each operating system release has more features and more compatibility requirements so that the application programs become larger. Software developers, in turn, must design new software to run on the new CPU and in a new system, while at the same time making the software “backward compatible” with older platforms. Some tasks, such as playing back audio, do not need much of a system's resources but are still forced to be designed to run on complex systems with huge amounts of memory and display capability. Even the simplest of tasks, such as providing a simple calculator for addition, must be wrapped in enough code to be compatible with the overall complex general-purpose computer platform. Before a programmer can write even a simple piece of code, the programmer must have a detailed understanding of the operating system environment, the required calls to handle user interfaces such as display and input devices, and other resource management.

Thus, it is desirable to improve upon the prior art.

### SUMMARY OF THE INVENTION

With the present invention, different processing devices, each having their own processor, memory and other dedicated resources, can operate within a single user interface and appear to a user in the traditional model of multiple processes executing on a shared CPU. In a preferred embodiment, a windows-like environment is provided where each device appears as a separate window. Windows can be moved, resized, closed and opened, as is known in the art. A user can interact with information within each window and, hence, immediately and simply access different devices.

An interface arbitrator accepts picture element information streams from each device. A device is informed by the arbitrator of the size of the device's associated window. The device outputs a sequence of words to define, in sequence, the display for the pixels within the window. The simply passes the stream data to the appropriate position of the display.

User input is obtained by the arbitrator. If a user performs an action, such as a mouse click, with a window, the arbitrator passes the location of the click to the associated device. The device performs the task of determining what object, if any, was clicked in the device's window.

The arbitrator can be used to designate shared resources, set priorities, launch and shut down devices, and perform other functions.

This approach allows manufacturers of consumer digital systems (both hardware and software) to have near complete control over their products. Further, each product is isolated, and protected, from other products, unless otherwise desired. Products that are simplistic, such as word processing or web browsing, can be created as a functioning system with low-cost early model chips and relatively small amounts of memory. Products that require specialized hardware can operate as closed systems so that no hardware or resource conflicts will occur, yet to the user it appears as if the system is providing all of the benefits of a multitasked operating system.

With some devices, no resource sharing is needed except for the user input and output devices allocated by the arbitrator. For example, a game designer can have direct access to arithmetic and graphic processors without regard to operating systems, drivers, etc. The manufacturer is free to choose the appropriate hardware, amount of memory, protection, features, etc. The manufacturer can then provide additional software as cartridges, CDROMs, DVDs, downloads, etc.

One embodiment of the invention provides a method for showing information from multiple processing devices. The method uses a display screen coupled to an interface arbitration system. The method comprises receiving first image information from a first processing device; displaying the first image information in a first window on the display screen; receiving second image information from a second processing device; and displaying the second image information in a second window on the display screen.

Another embodiment provides an apparatus for sharing a display screen among two or more processing devices. The method includes a first input for receiving image information from a first processing device; a second input for receiving image information from a second processing device; and an output for outputting a signal to a display screen, including at least a portion of image information from each of the first and second processing devices displayed simultaneously on the display screen.

Another embodiment provides a method for directing a signal from a user input device among first and second processing devices, the method comprising receiving a signal from the user input device; determining that the signal is designated for one of the first or second processing device; and transferring at least an indication of the signal to the designated processing device.

Another embodiment provides a game console system comprising a first connector for coupling a personal computer display signal to the game console; a display output for outputing a display signal to a display device; and a selector for selectively coupling either a game console display signal or the personal computer display signal to the display device.

### BRIEF DESCRIPTION OF THE DRAWINGS

FIG. 1 is a block diagram illustrating the invention;

FIG. 2 illustrates the user interface display of a preferred embodiment of the present invention;

FIG. 3A shows an embodiment of the invention including possible connections to a personal computer;

FIG. 3B shows a device for arbitrating among processing systems included in cartridges;

FIG. 3C illustrates an embodiment where a network connection is provided via a cartridge;

FIG. 4 shows a game console that allows a user to access a personal computer by selective switching of input/output signals.

### DETAILED DESCRIPTION OF A PREFERRED EMBODIMENT

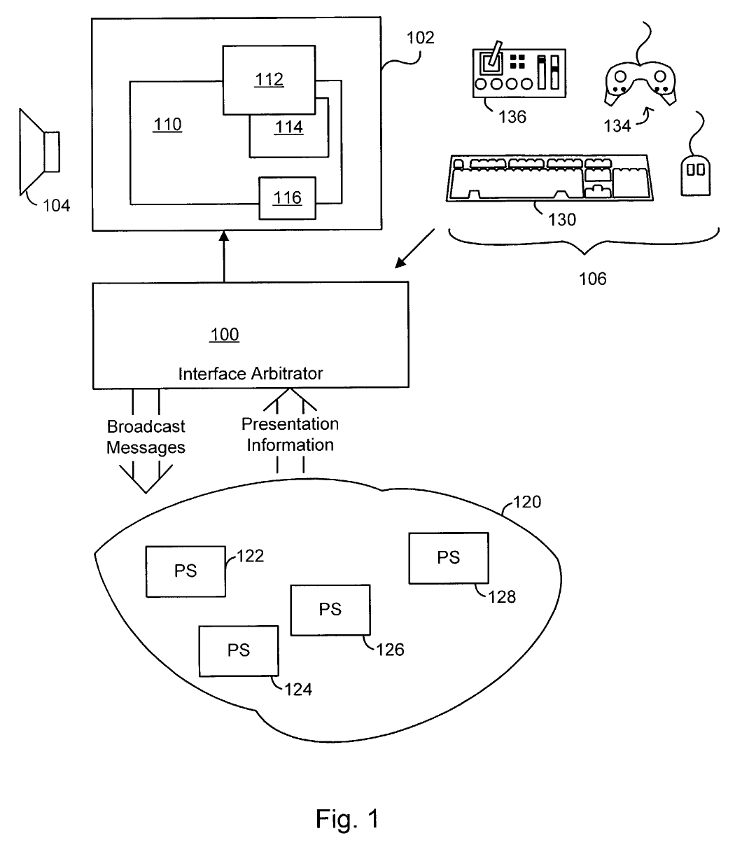

FIG. 1 illustrates a preferred embodiment of the invention.

In FIG. 1, arbitrator 100 receives presentation signals, such as image and audio information, from processing devices at 120. Processing devices include any type of consumer electronic device, software application or combination of software and hardware to achieve a task or perform a function or operation. For example, a music player, video playback device, word processor, web browser, computer system, or other device is suitable for use with the present invention.

Arbitrator 100 routes presentation signals to output devices such as display 102 and speaker 104. In general, any type of presentation device can be used with the present invention. For example, display screens, monitors, projection displays, etc., can be used to present visual information. Devices for presenting audio can include speakers for stereo, surround sound, or other formats; piezo devices, tone generators, musical instrument data interchange (MIDI) devices, buzzers, bells, or other devices that are electrically responsive to produce sound.

Arbitrator 100 also receives input from user input devices such as those shown at 106. Again, any type of user interface device that allows a user to provide an input can be employed. For example, a mouse, trackball, touch screen, data glove, video imaging sensor or other position sensor, digitizing tablet, eye position sensor, biometric, or other type of input device can be used.

The arbitrator generates signals for the display device to create a user interface similar to other popular user interfaces such as Microsoft's Windows, or the Apple Operating Systems, that use a so-called “desktop metaphor.” Naturally, other embodiments do not need to try to use characteristics of other interfaces. However, users are familiar with, and can readily use, an interface that behaves similarly to one that is popular, such as the aforementioned interfaces. In one embodiment, the arbitrator creates windows to allow multiple processing devices to appear as multiple windows on the display corresponding to the multiple processing devices.

In general, processing devices differ from the multiple software tasks, or programs, in the prior art that share resources. Processing devices can have their own dedicated CPU, memory, and other basic computer architecture features. However, the hardware of processing devices need not follow a general-purpose processing approach but can use application-specific integrated circuit (ASIC), gate array, field-programmable gate array (FPGA), discrete, custom, semi-custom, or other design approaches, or a mix of such approaches. Processing devices can include subsystems such as network interfaces, modems, graphics accelerators, etc. Processing devices can even provide user interface mechanisms and output devices such as image and audio devices.

Some processing devices can be integrated with the arbitrator as a unit. Other processing devices can be separable so that independent design and manufacture by different companies is made easier. Processing devices can include means for bypassing the arbitrator, or otherwise communicating with a user, network, or other devices in a manner that does not include all, or any, arbitrator interaction. Many deviations of processing devices from those described here will be apparent and are within the scope of the present invention.

In FIG. 1, windows 110, 112, 114 and 116 are shown as overlapping rectangular windows. Each of these windows corresponds to a different physical device. Windows 110, 112 114 and 116 correspond to devices 122, 124, 126 and 128, respectively. Naturally, any number of devices and windows can be used. In some embodiments of the invention, a device can have multiple windows, or no windows. Window operations such as opening, closing, resizing, moving, activating, etc. can be performed as is known in the art. Other aspects of the windows can be implemented, as desired.

One embodiment of the invention does not use a complicated operating system approach. Rather than requiring processing devices to follow intricate messaging protocols to open, manage, maintain and operate windows, the present invention merely accepts “image information” from each device. In a preferred embodiment, the image information is a series of binary values that define the color and intensity for each picture element (“pixel”) in the processing device's window area. Note that any definition of a pixel's display value is acceptable. The image information can be compressed, encrypted, or otherwise modified, as desired. The image information will typically include auxiliary information such as an identifier to indicate to which processing device the image information is associated. Other information can be included such as a frame display rate, timestamp, etc.

The arbitrator's task is greatly simplified since, in a preferred embodiment, the arbitrator only needs to store the image information stream for a given device directly into the display memory area corresponding to the device's window. The arbitrator does not need to know anything further about the information. Thus, in a preferred embodiment the arbitrator does not deal with object definitions, rules, properties, names, operating system requirements, or other aspects or attributes of the displayed information. Nor is the arbitrator concerned with managing the contents within a window. In a preferred embodiment, the arbitrator's task of managing content in a window is merely to transfer the pixel definitions in an image information stream into the corresponding device's window. If the device supplies too much, or too little information, (i.e., more or less than the window can hold), then the window will show an erroneous result such as a fraction of an intended window image, left over blank space or previous images, garbage images, etc. Note that other embodiments of the arbitrator can allow more complex specification of window properties and more detailed control of windows by, or interaction of windows with, processes. Other embodiments can also use various aspects of traditional image display within windows such as using registration, messaging, callback routines, predefined objects, animations (e.g., dragging, resizing, button clicking), etc.

In a preferred embodiment the arbitrator handles window overlap and focus. The arbitrator calculates clipping of pixel information based on other windows that may be overlapping a given device's window. In general, only one window will be “active” or “in focus.” Other non-active windows do not need to have their displays updated. In a preferred embodiment, the arbitrator sends status information to each device to tell the device whether the device's window is active or not. If not active, a device does not need to send image information. However, any image information sent can be selectively be displayed so that even non-active windows can have updating displays. The arbitrator indicates an active window by, e.g., highlighting the window's title bar, as is known in the art, or by other means such as fading out non-focused windows.

In the preferred embodiment window resizing operations are performed by the arbitrator. However, the arbitrator does not attempt to “fit” image information within a window by recalculating (i.e., scaling) the image information. The preferred embodiment leaves such scaling functions to each processing device as the device is better able to scale or clip images within the device's window, and to make decisions about managing the device's changing display area. In other embodiments, the arbitrator can perform functions such as scaling pixel information streams so that a device can assume that its display dimensions are fixed.

The arbitrator sends status and user-input information back to the devices. As mentioned, part of the status includes the device's window dimensions and whether the device's window is an active window. An active window is typically a window that is currently being updated in real time and a window within which a user can make selections. The arbitrator receives signals from a user input device and notifies a device when the user performs an action within the device's window. For example, if a user moves a pointer into a device's window and then makes a mouse button click, or selection, the coordinates of the pointer at the time of the click, and the fact that a click occurred, are transmitted to the corresponding device. In a preferred embodiment, the arbitrator provides x,y coordinates for the mouse click with respect to the upper-left corner of a window display area. Naturally, any scheme for indicating locations and operations with a device's window can be used.

Other types of user input can be provided, such as a mouse “button up” event. In general any type of user interface device can be used with the present invention including those shown in FIG. 1 as keyboard 130, mouse 132, gamepad 134, or an arbitrary controller as represented by 136 having various controls, etc. Any type of control including button, slider, knob, switch, joystick, touchpad, proximity sensor, imaging device, etc. manipulation or signal can be sensed such as whether a button is pressed or released; keyboard keys being pressed, trackball motion, stylus or touching coordinates (e.g., for tablet or touchscreen inputs), etc. The arbitrator's task is simplified since it reports the relative positions of user actions within a device's window to a processing device and the processing device is expected to take appropriate action. From the devices' point of view, each device need only perform simple comparisons of the relative positions with device's local data, such as image maps or area coordinates, to determine which objects within a device's window are being manipulated. Note that devices can have multiple windows within the window managed by the arbitrator. These multiple windows are not handled by the arbitrator, but are, instead, handled by the device.

Using the approach of the present invention, large systems such as game consoles, personal computers, etc., can be treated as processing devices (such as 122) for purposes of interface arbitration. For example, a user can be presented with a traditional single personal computer system with dedicated display and user input devices by merely enlarging a window corresponding to the personal computer to fill the entire screen of the display. When the user desires to use a different device, such as a game console, the personal computer's window is minimized. Minimization can include closing the personal computer window and placing an icon representing the personal computer on a small “task bar” at one side of the screen. The game console window is then enlarged to fill the screen. Such a specific embodiment of an arbitrator integrated with a game console system is described, below, following the next section discussing details of the graphical user interface.

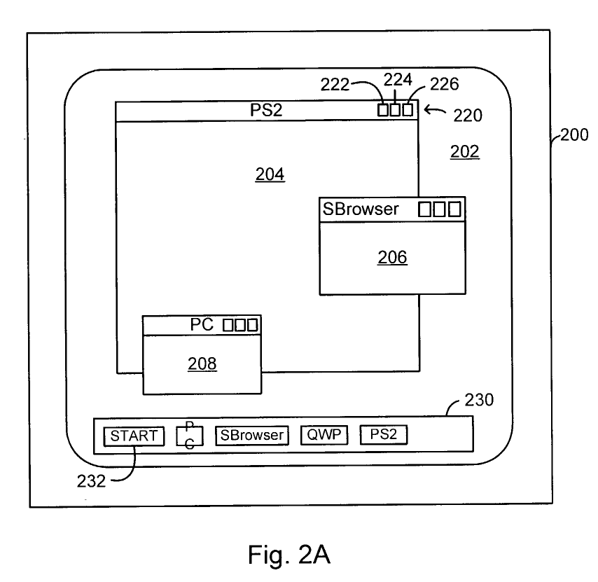

FIG. 2 illustrates the user interface display of a preferred embodiment of the present invention.

In FIG. 2, display device 200, includes display screen 202 upon which windows 204, 206 and 208 are currently displayed. Each window has similar controls that are most easily seen on window 204 as title bar 220, maximize button 222, minimize button 224 and close button 226. As with traditional operating systems, a user can use a pointer to move the window by dragging the title bar. The window can be resized by clicking and dragging on the sides of the window. The minimize button removes the window from the display screen area and places it on taskbar 230 as a button, or small icon. Clicking on a minimized window's icon causes the window to be restored to its former size and position.

Using the maximize button causes the window to fill up the entire display area. Clicking the close button causes the device to be turned off, or to go into a “sleep” or less active mode. Devices can be started by using start button 232. Alternatively, devices can be started by using an on/off switch on the physical device, by using a menu system or by other means. The functionality of the user interface can be achieved in many ways as is known in the art. For example, the taskbar buttons can be icons on a desktop, or in a file folder. Exploring and organizing folders, files, icons, data, etc., can use many different approaches as is known in the art. For example, a command-line with text commands can be used.

When a user clicks on or within a window the window becomes active. The device corresponding to the window is informed that the device's window is active. If the user has selected (e.g., by clicking, touching, pointing, or by other means) a region within a device's window, the device is informed of the selection point. Communication between the arbitrator and the devices can be by any means as is known in the art including wire and wireless communication, optical, or other means.

A preferred embodiment of the invention is called an “allbox”. The allbox is designed to allow third party manufacturers of consumer electronic devices to receive consumer acceptance in a marketplace that may be dominated by one or a few computer platforms. For example, the combination of Microsoft operating system and Intel CPUs (sometimes referred to as “Wintel”) presents a large market barrier for consumer software and hardware developers. Unless a product is designed to run on the Wintel platform, there is often little chance of success in penetrating the market because of the large installed base of consumers already using the Wintel platform.

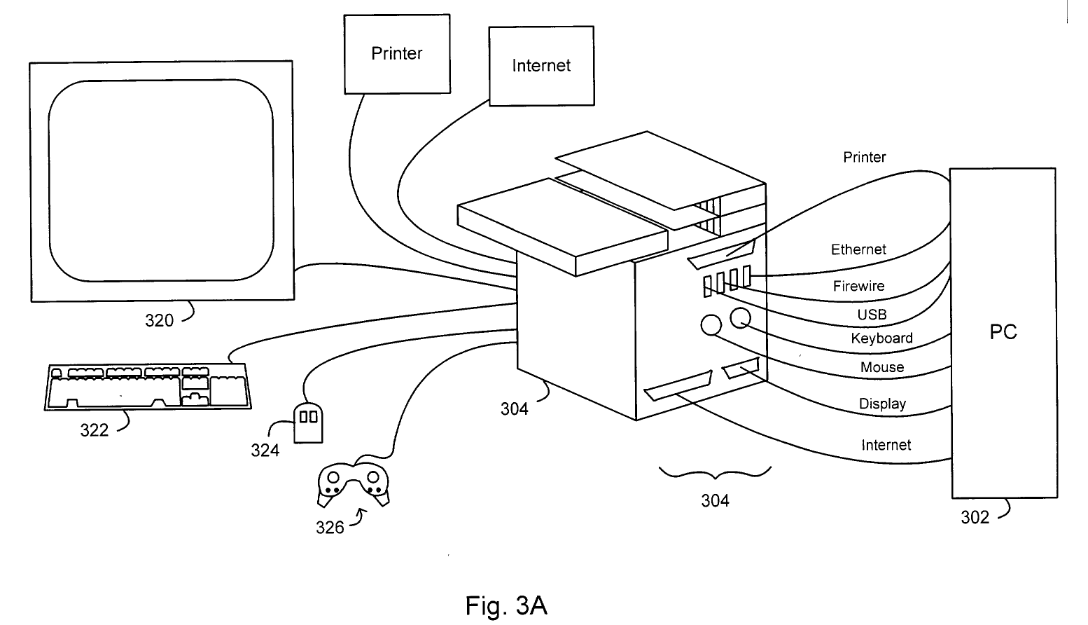

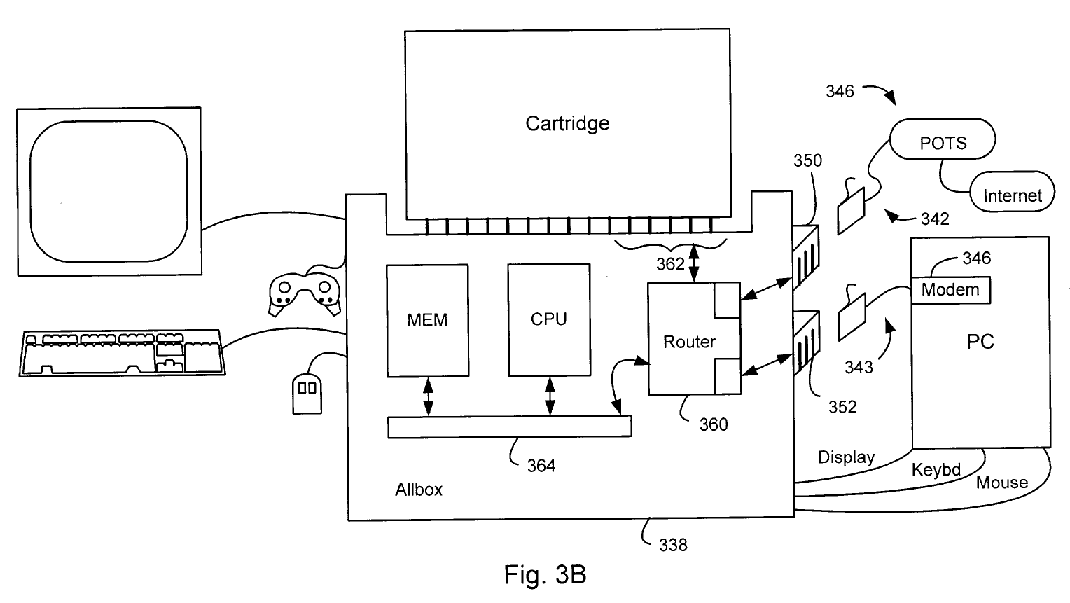

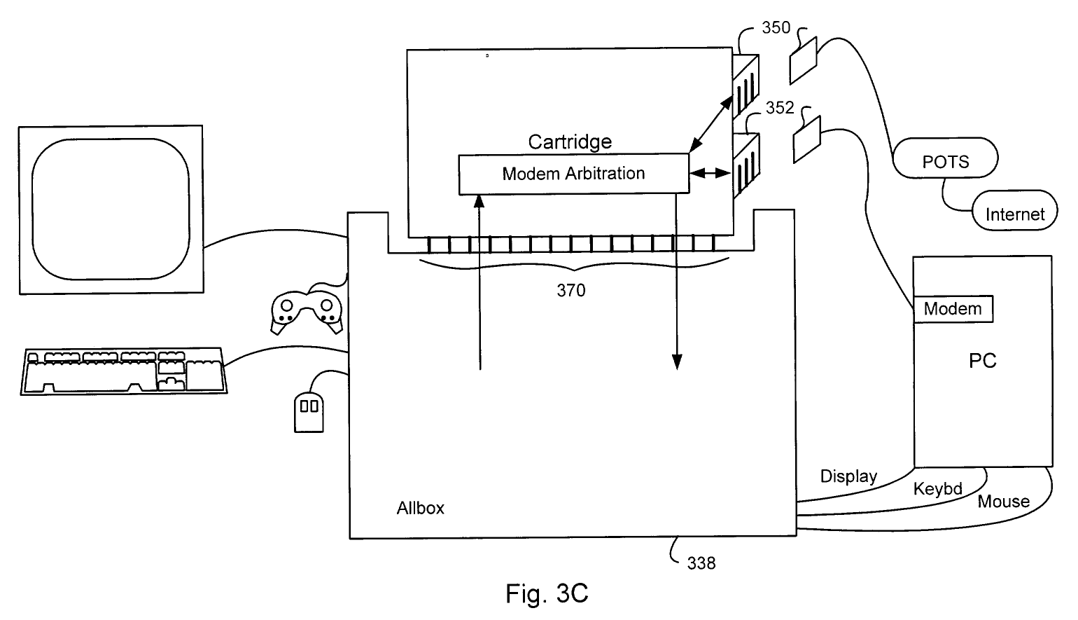

The allbox is illustrated in FIG. 3A. Allbox 300 accepts connections from PC 302 via standard connectors illustrated at 304. Such a PC can use the Wintel platform, or any type of CPU and operating system. Typical types of connections to/from a PC include display, keyboard, mouse, printer (e.g., via a serial port); network connections such as IEEE 1394 (“Firewire”), Universal Synchronous Bus (USB), Small Computer System Interface (SCSI), modem, etc. Many other types of connections are possible such as cable modem, Digital Subscriber Line (DSL), wireless (e.g., 802.11, Bluetooth), etc. Naturally, any number and type of connections can be made. It is not necessary to have all connections to achieve some of the features of the present invention. All that is necessary, at a minimum level, is that the allbox be able to control a PC's access to user interface resources such as display 320, keyboard 322 and mouse 324. Some embodiments of the invention may merely use arbitration of these three devices, although any number and type of resources can selectively be arbitrated, as discussed below.

In a preferred embodiment, the allbox includes hardware and software components of a game console such as Sony's Playstation II, Microsoft's X-box, Nintendoe's Game Cube, etc. Thus, the allbox, itself is a consumer device that allows a user to have many of the functions and features of a typical game console. A user can load entertainment, educational, commercial, or other software. Additionally, the allbox allows arbitration of other devices such as a PC or processing device cartridge so that a user can run many devices from a single workspace (i.e., single combination of display and user input devices). The user need only plug the display and input devices into the allbox. These resources are then arbitrated among the game console functions, the PC and other processing devices incorporated into cartridges that are mated to the allbox.

A preferred embodiment of the allbox, next discussed, includes a minimal amount of connections. For example, display, user input and Internet connections are provided and arbitrated. This preferred embodiment is illustrated in FIG. 3B.

In FIG. 3B, device cartridge 340 is an Internet browser. In a preferred embodiment, connectors 350 and 352 are mounted on the allbox. A PC's internal modem is connected to one connector and a phone line connection is made to the other. Router 360 can pass data to and from the PC modem and the telephone system. Router 360 can also route information to and from one or more pins on the allbox cartridge bus, such as those pins shown at 362, or to a bus internal to the allbox shown at 364. Thus, components within allbox 338 such as memory, CPU, etc., can access an Internet connection via phone line 342 for communications to an external processes or devices on the Internet. Note that any type of network connection and functionality can be provided in this manner. For example, the physical connection can be by cable modem, DSL, local area network (LAN), wireless network, etc.

Cartridges, and components within cartridges, are provided with access to the Internet by using pins 362 to communicate with router 360. Note that any type of transmission of data can be used such as buses, wires, pins, wireless infrared or radio frequency communications, fiber optic, etc. In general, any data transmission discussed herein can be by any suitable means, using any type of physical link, topology, protocol, mechanism or other aspect of data communication technology.

Router 362 can be a simple automated relay, multiplexer or other type of electronic switch to connect the four conductors of phone lines such as 342 and 343 together. Or to connect phone line 342 with four pins at 362, etc. However, this approach requires that devices must disconnect and re-connect to the telephone system every time a different device exchanges data with the Internet. Since the process of dialing and connecting is on the order of tens of seconds, such an approach may not be desirable. Even where connections may be established more quickly (e.g., DSL, cable modem) other relatively lengthy connection considerations, such as login or account verification by an Internet Service Provider (ISP), may still result in intolerable delays.

Another approach, used in a preferred embodiment, is to provide the router with enough functionality so that an Internet connection can be maintained regardless of switching among devices communicating over a limited connections. For example, the router can act as a switch or hub, as is known in the art, to arbitrate the Internet channel among multiple devices. In the case where a PC is using a modem, the router acts as a web site and sets up transactions with the PC modem according to Internet Protocol (IP). The signals from the PC are demodulated/decoded and signals to the PC are modulated and encoded. Thus, to the PC modem, it appears that a modem phone line connection with the Internet has been established. Note that components within cartridges and the allbox can communicate with the router by any efficient means such as using a digital data bus, network, etc. The modem arbitrator modulates and demodulates all data to the phone network, as necessary, to establish standard modem communications.

Thus, the router can appear to the PC as the entire Internet. The router can set up secure socket layer (SSL) communications, can relay web media content, and perform other aspects of transferring Internet content. Note that the router, in addition to apportioning Internet access among devices, can also monitor and modify data being transferred. For example, the router can add or remove information such as banner advertisements, hyperlinks, images, etc. The router can screen data for viruses, provide anonymous Internet accessing, provide a firewall to specified types of data, or to sources or destinations of data. Other features are possible.

FIG. 3C illustrates an alternative approach where the network connection is provided through a cartridge. Connectors such as 350 and 352 are now located on cartridge 340 rather than allbox 338, in contrast to the embodiment shown in FIG. 3B. Thus, the approach of FIG. 3C allows different physical connectivity to be added after the allbox is purchased. This approach allows a buyer to “upgrade” the allbox as standards, needs, designs, resources, etc., change. For example, although a user may purchase an allbox without Internet connectivity ability, such ability can be added later by purchasing a cartridge, such as cartridge 340 of FIG. 3C, that can provide telephone modem, cable modem, DSL, etc., connectors.

Signals from the connectors are routed through some of the pins (or other types of detachable connections) on allbox bus 370. Note that any number of the pins can be used. Typically, pins will be reserved for expansion purposes. Alternatively, the internal allbox bus can use a shared bus protocol to allow data from cartridges—including signal information from connectors mounted onto, or within, cartridges—to be passed from cartridge connector to allbox 338. Data can also be passed among cartridges directly (i.e., without substantial processing or direction from allbox circuitry). Some embodiments need not pass signals from cartridge connectors to the allbox or to other cartridges. In other words, signals from a specific cartridge's connector or connectors can be handled completely within the specific cartridge.

In a preferred embodiment, priorities can be assigned so that, for example, while a user is playing a game over the Internet, the game (executed by components within the allbox) is provided with greater Internet access than other components (including the PC).

A preferred embodiment of the invention allows the allbox to be “invisible” to processing devices. In the invisible, or “stealth,” mode of operation, processing devices can output display signals as if the processing devices were outputting to a standard display (e.g., computer monitor, flat panel display, television, etc.). Any type of format can be accommodated. Similarly, inputs to processing devices from the allbox are made so that the input signals emulate signals that would be sent directly from an input device. For example, when using a mouse as an input device, the allbox passes the mouse x, y position change signals directly to a processing device.

In stealth mode, since a processing device is being tricked into believing that it is the sole device connected to input and output devices, some corrections need to be made if the processing device is forced to run in a window less than the full size of a display screen. In a first approach, the allbox scales the image information so that the entire processing device display is miniaturized, or scaled down, to fit within the window. In this approach, sizes and distances of objects in the processing device's display signal maintain their relative relationships. With this scaling down approach, the mouse or pointer positions and movements within the window must be appropriately adjusted so that the processing device can accurately track the mouse position.

For example, if a processing device's window is one-half as tall and one-half as wide as a full display screen, then mouse movement signals must be blocked while the pointer is not within the window. When the pointer moves within the window, the allbox must “jump” the pointer to the position within the window and then scale the pointer movement so horizontal and vertical movements are multiplied by 2.

Note that many processing devices, such as personal computers, will create their own display of a pointer. It is possible to merely use this device-generated pointer image while the device's window is active. A drawback to this approach is that the pointer size changes as the size of the screen window changes. However, an advantage is that no tracking and correcting of pointer positions need be done by the allbox.

Another approach to stealth mode is to clip the image information when a device's window is less than the entire display. In such an approach, the window can be provided with horizontal and vertical scroll bars. Or the window can automatically scroll when the pointer is near an edge. This approach has the advantage that mouse movements do not have to be scaled. Also, if the device-generated pointer image is used then it will not change size depending on the size of a device's window. An obvious disadvantage is that a user can not see all of a device's intended display.

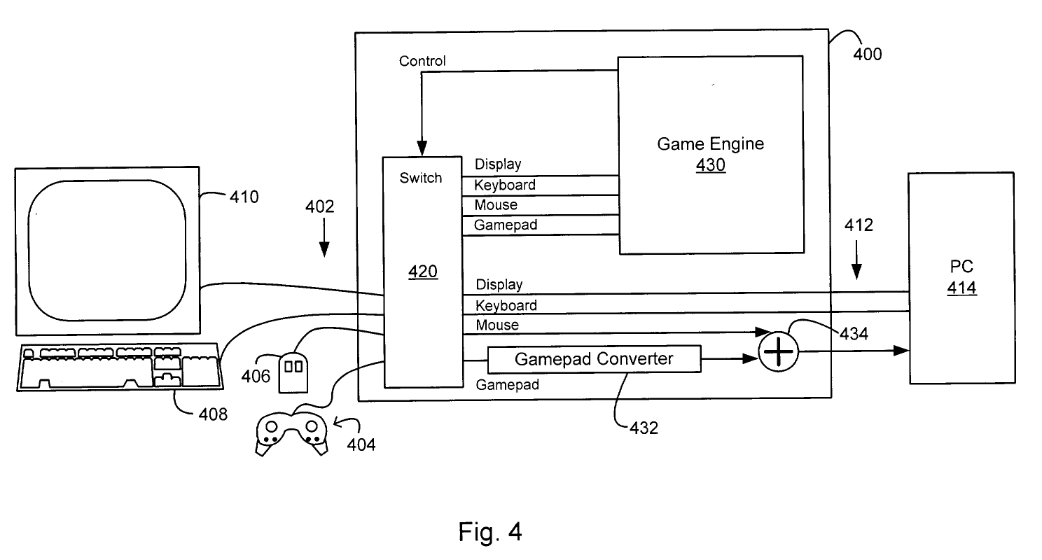

FIG. 4 illustrates a simplified embodiment of the present invention.

In FIG. 4, game console 400 includes connectors at 402 for devices such as gamepad 404, mouse 406, keyboard 408 and display device 410. Some embodiments may have fewer, more or different connectors. For example, a typical embodiment may only use gamepad 404 as an input device and omit mouse 406 and keyboard 408.

Game console 400 also includes connectors at 412 for connecting to a PC. In the example of FIG. 4, PC 414 connects to game console 400 with its display, keyboard and mouse connectors. The game console includes switch 420 that selectively couples the signals from connectors at 402 to either game engine 430 or PC 414 via connectors at 412. Control of the switching can be by game engine 430 or by some other internal or external device or signal (not shown). Note that switching can be accomplished by any suitable mechanism such as, e.g., a multiplexer, discrete solid state or mechanical switches, data routing on a bus, etc.

In a preferred embodiment, a digital processor in game engine is responsive to a “select” button or other control on gamepad 404 to allow a user to switch the signals. Note that the signal from the select button will always be coupled to game engine 430, in this case. An alternative embodiment can use an on-screen icon, or other control, displayed on display device 410. The user can manipulate a pointer to click or select the icon to cause switching.

As signals are switched between game engine 430 and PC 414, the user is able to interact with the different devices. PC 414 does not need to “know” that its inputs and outputs are being controlled. In this manner, a user can switch between functionality provided by the game console (such as playing a game) to functionality provided by the PC (such as accessing a word processing file, browsing the Internet, etc.).

Since PC 414 expects mouse signal inputs, and since gamepad 404 typically does not output such signals, gamepad converter 432 is used to convert a gamepad control to mouse signals. For example, pushbuttons on gamepad 404 can be used to indicate left-right and up-down movements that are analogous to a mouse's movements. Some gamepads also include a thumb controlled joystick-type of control whose signals can be converted to mouse movement signals. In a preferred embodiment, a user can hook up a mouse to the game console. In this case, either mouse 406 or gamepad 404 can be used as mouse inputs to PC 414. The two inputs are summed by combiner 434. Other approaches to allowing non-mouse input devices to emulate a mouse can be employed.

Any type of user input device can be coupled to game console 400. For example, a trackball, touchpad, digitizing tablet, etc. can be used and converted, as necessary. Other inputs to the PC can be used. More, less or different types of connections can be used. For example, a port, bus, network or communication link can be coupled to game console 400. Such a communication link can be passed through to devices at the user connectors at 402. This can allow various third party input devices (e.g., a data glove, virtual reality goggles, etc) to be used.

Although the invention has been described with respect to specific embodiments thereof, these embodiments are merely illustrative, not restrictive, of the invention. For example, the interface arbitrator can arbitrate among multiple output devices such as multiple display screens and speakers, rather than the single display device discussed herein. Means of data sharing can be implemented such as by using memory in the arbitrator for a clipboard to, e.g., transfer text information from one device to another by copying and pasting via a suitable graphical interface.

Router 362 can be provided with pin connectivity that is automatically selectable so that pins used to,carry modem information can be changed. For ease of discussion the invention has been described with respect to telephone modem interfaces. However, it should be apparent that any type of data transfer method can be used. For example, a television set can be made to operate in a window. As discussed, above, any type of device or devices can be integrated with an arbitrator. Other add-on devices can then be coupled to the unit to provide any additional functionality, resources or other features that are operable within the arbitrated environment.

Although reference has been made to an “application program,” or “program,” any type of executable software, firmware or even hardware-implemented process or function, can be allocated with resources. A program, application, routine, dynamically linked library, plugin, object, task or other type of executable instruction, code or logic, can be the subject of a resource allocation.

Thus, the scope of the invention is to be determined solely by the appended claims.

In the claims:

1. A method for showing information from multiple processing devices, the method using a display screen coupled to an interface arbitration system, the method comprising
receiving first image information from a first processing device;
displaying the first image information in a first window on the display screen;
receiving second image information from a second processing device; and
displaying the second image information in a second window on the display screen.

2. The method of claim 1, wherein the image information includes picture element information.

3. The method of claim 1, wherein the image information includes a digital video signal.

4. The method of claim 1, wherein the image information includes an analog video signal.

5. The method of claim 1, the method further comprising
accepting signals from a user input device coupled to the interface arbitration system to designate the first window as an active window;
receiving signals from a user input device coupled to the interface arbitration system to indicate a user selection of an area within the active window; and
transferring an indication of the selected area to the first processing device.

6. The method of claim 1, wherein at least one processing device is a computer system.

7. The method of claim 1, wherein at least one processing device is a game console.

8. An apparatus for sharing a display screen among two or more processing devices, the device comprising
a first input for receiving image information from a first processing device;
a second input for receiving image information from a second processing device; and
an output for outputing a signal to a display screen, including at least a portion of image information from each of the first and second processing devices displayed simultaneously on the display screen.

9. A method for directing a signal from a user input device among first and second processing devices, the method comprising
receiving a signal from the user input device;
determining that the signal is designated for one of the first or second processing device; and
transferring at least an indication of the signal to the designated processing device.

10. An apparatus for directing a user input signal among first and second processing devices, the apparatus comprising
an input for receiving the user input signal;
a display output for providing a signal to a display device to show first and second windows corresponding to the first and second processing devices;
a detection mechanism for detecting whether the user input signal is designated for the first or the second processing device; and
a signal output for sending at least an indication of the signal to the designated processing device.

11. The apparatus of claim 10, further comprising
a window defining mechanism for
a determination mechanism for determining

12. A game console system comprising
a first connector for coupling a personal computer display signal to the game console;
a display output for outputing a display signal to a display device; and
a selector for selectively coupling either a game console display signal or the personal computer display signal to the display device.

13. A game console system comprising
a first connector for coupling a personal computer mouse input to the game console;
a second connector for coupling the game console to a gamepad user input device; and
a switch coupled between the first and second connectors for selectively coupling the gamepad user input device to the personal computer mouse input.
